(19) United States
(12) Patent Application Publication
(10) Pub. No.: US 2022/0094075 A1
(43) Pub. Date: Mar. 24, 2022

(54) DUAL-FEED DUAL-BAND INTERLEAVED ANTENNA CONFIGURATION

(71) Applicant: QUALCOMM Incorporated, San Diego, CA (US)

(72) Inventors: Jeongil Jay KIM, San Diego, CA (US); Li LIU, San Diego, CA (US); Kevin Hsi-Huai WANG, San Diego, CA (US)

(21) Appl. No.: 17/028,280

(22) Filed: Sep. 22, 2020

(51) Int. Cl. H01Q 21/08; H01Q 5/307; H01Q 9/04; H01Q 1/24

(52) U.S. Cl. CPC H01Q 21/08; H01Q 1/243; H01Q 9/0435; H01Q 5/307

(57) ABSTRACT

Techniques are provided for improving the bandwidth of a dual-band antenna in a mobile device. An example wireless device includes at least one radio frequency integrated circuit, and at least one patch antenna array operably coupled to the least one radio frequency integrated circuit, comprising a first rectangular patch including a first side and a second side, wherein a length of the first side is greater than a length of the second side, and a second rectangular patch including a first side and a second side of the same dimensions as the respective first side and the second side of the first rectangular patch, wherein the first side of the second rectangular patch is disposed adjacent and parallel to the second side of the first rectangular patch.

### BACKGROUND

A wireless device (e.g., a cellular phone or a smart phone) may include a transmitter and a receiver coupled to an antenna to support two-way communication. The antenna may be enclosed within a housing assembly (e.g., cover) based on portability and aesthetics design considerations. In general, the transmitter may modulate a radio frequency (RF) carrier signal with data to obtain a modulated signal, amplify the modulated signal to obtain an output RF signal having the proper power level, and transmit the output RF signal via the antenna to a base station. For data reception, the receiver may obtain a received RF signal via the antenna and may condition and process the received RF signal to recover data sent by the base station. As the radio frequency used by the wireless device increases, the complexity of the RF transmitting circuitry also increases. To facilitate and/or enable wireless signal applications, numerous types of antennas have been developed, with different antennas used based on the needs of an application, e.g., distance, frequency, operational frequency bandwidth, antenna pattern beam width, gain, beam steering, etc. Newer RF technologies and wireless devices are becoming more reliant on dual-band performance.

### SUMMARY

An example wireless device according to the disclosure includes at least one radio frequency integrated circuit, and at least one patch antenna array operably coupled to the least one radio frequency integrated circuit, comprising a first rectangular patch including a first side and a second side, wherein a length of the first side is greater than a length of the second side, and a second rectangular patch including a first side and a second side of the same dimensions as the respective first side and the second side of the first rectangular patch, wherein the first side of the second rectangular patch is disposed adjacent and parallel to the second side of the first rectangular patch.

Implementations of such a wireless device may include one or more of the following features. The first rectangular patch may include a first feed point disposed proximate to an edge of a third side that is opposite and parallel to the second side of the first rectangular patch, and a second feed point disposed proximate to an edge of the first side of the first rectangular patch. The first feed point may be configured to send or receive energy having a first frequency, and the second feed point is configured to send or receive energy having a second frequency. The first frequency may be approximately 28 GHz and the second frequency is approximately 39 GHz. The second rectangular patch may include a first feed point disposed proximate to an edge of a third side that is opposite and parallel to the second side of the second rectangular patch, and a second feed point disposed proximate to an edge of the first side of the second rectangular patch. The first feed point may be configured to send or receive energy having the first frequency, and the second feed point may be configured to send or receive energy having the second frequency. A distance between a center of the first rectangular patch and a center of the second rectangular patch may be approximately a quarter of a wavelength of an operational frequency. The at least one patch antenna array may further include a third rectangular patch of the same dimensions and orientation as the first rectangular patch and disposed adjacent to the second rectangular patch, and a fourth rectangular patch of the same dimensions and orientation as the second rectangular patch and disposed adjacent to the third rectangular patch, such that the second rectangular patch may be disposed between the first rectangular patch and the third rectangular patch, and the third rectangular patch may be disposed between the second rectangular patch and the fourth rectangular patch.

An example patch antenna array according to the disclosure includes a first plurality of rectangular patches in a first orientation, and a second plurality of rectangular patches in a second orientation, wherein the first plurality of rectangular patches and the second plurality of rectangular patches are disposed in an interleaved order in a row such that each rectangular patch in the first plurality of rectangular patches is adjacent to at least one rectangular patch in the second plurality of rectangular patches.

Implementations of such a patch antenna array may include one or more of the following features. Each of the rectangular patches in the first plurality of rectangular patches and the second plurality of rectangular patches may include a first feed point and a second feed point. The first feed point may be configured to send or receive energy having a first frequency and the second feed point is configured to send or receive energy having a second frequency. The first feed point may be configured to send or receive energy having the first frequency at a first polarization and the second feed point may be configured to send or receive energy having the second frequency at a second polarization. Each rectangular patch of the first plurality of rectangular patches and the second plurality of rectangular patches has a first side, a second side, a third side, and a fourth side, such that the four sides are similarly disposed in all of the rectangular patches in the first plurality of rectangular patches and the second plurality of rectangular patches, such that the first feed point of all of the rectangular patches in the first plurality of rectangular patches and the second plurality of rectangular patches is disposed adjacent the first side, such that the second feed point of all of the rectangular patches in the first plurality of rectangular patches is disposed adjacent the third side, and such that the second feed point of all of the rectangular patches in the second plurality of rectangular patches is disposed adjacent the fourth side. The first side is parallel the second side, wherein the third side is parallel to the fourth side, such that the first plurality of rectangular patches comprises at least two rectangular patches, and wherein the second plurality of rectangular patches comprises at least two other rectangular patches. The first plurality of rectangular patches may include four rectangular patches and the second plurality of rectangular patches includes four rectangular patches. Each of the rectangular patches in the first plurality of rectangular patches and the second plurality of rectangular patches may include two parallel sides that are approximately 2.5 millimeters in length and two parallel sides that are approximately 2.0 millimeters in length. The patch antenna array may further include a first plurality of passive patch elements in the first orientation, and a second plurality of passive patch elements in the second orientation, wherein each of the passive patch elements in the first plurality of passive patch elements is disposed above a respective rectangular patch in the first plurality of rectangular patches, and each of the passive patch elements in the second plurality of passive patch elements is disposed above a respective rectangular patch in the second plurality of rectangular patches.

An example method for operating an antenna system according to the disclosure includes operating a first rectangular patch element to send or receive energy having a first frequency or a second frequency, wherein the first rectangular patch element is in a first orientation, and operating a second rectangular patch element to send or receive energy having the first frequency or the second frequency, wherein the second rectangular patch element is in a second orientation and disposed adjacent to the first rectangular patch element.

Implementations of such a method may include one or more of the following features. The method may include operating the first rectangular patch element to send or receive energy having the first frequency at a first polarization and the second frequency at a second polarization, and operating the second rectangular patch element to send or receive energy having the first frequency at the second polarization and the second frequency at the first polarization. The antenna system may be operated in a carrier aggregation operation.

Items and/or techniques described herein may provide one or more of the following capabilities, as well as other capabilities not mentioned. A plurality of rectangular patches may be disposed on a substrate. The length and width of the rectangular patches may correspond to different operational frequencies. The orientation of the rectangular patches may alternate from patch to patch in an array. Each rectangular patch may include feed points for a first operational frequency and a second operational frequency. The feed points on each patch may be associated with different signal polarizations. An array may include one or more passive patch elements. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 shows a wireless device capable of communicating with different wireless communication systems.

FIG. 2 shows a wireless device with a 2-dimensional (2-D) antenna system.

FIG. 3 shows a wireless device with a 3-dimensional (3-D) antenna system.

FIG. 4 shows an exemplary design of a patch antenna.

FIG. 5 shows a side view of an example patch antenna array in a wireless device.

FIGS. 6A and 6B show examples of dual-band patch antennas.

FIG. 7 shows a top view of an example dual-feed dual-band interleaved antenna array.

FIG. 8 shows a side view of an example dual-feed dual-band interleaved antenna array.

FIG. 9 is an example process flow for sending or receiving a signal with a dual-feed dual-band interleaved antenna array.

### DETAILED DESCRIPTION

Techniques are discussed herein for improving the bandwidth of a dual-band antenna in a mobile device. For example, many mobile devices include millimeter-wave (MMW) modules to support higher RF frequencies (e.g., 5^{th} Generation specifications). In general, MMW 5G provides wide bandwidths in small cells, which may require a phased array antenna to overcome high signal propagation loss at mmWave. A single phased array antenna module to support multiple MMW bands such as 28 GHz and 39 GHz is desired to reduce module size and cost. Some existing dual-band antenna modules utilize a single-feed dual-resonance patch array, which may have limited bandwidth at one of the operating frequencies and/or be associated with sub-optimal dual-band Power Amplifier (PA) and Low Noise Amplifier (LNA) performance. Certain embodiments of the single-feed dual-resonance patch array also may be inappropriate for 28 GHz and 39 GHz inter-band Carrier Aggregation (CA) operations because the single feed may not allow simultaneous 28 GHz and 39 GHz PA/LNA operations. The dual-feed dual-band antenna array described herein provides increased bandwidth at one or more operating frequencies, for example at 28 GHz and 39 GHz, and separates the feeds for the signal paths of two operating frequencies, which may allow for improved PA/LNA performance and CA operations. For example, in a carrier aggregation operation, the dual-feed dual-band antenna array described herein may simultaneously receive or transmit on one or multiple component carriers such as the 28 GHz and 39 GHz bands.

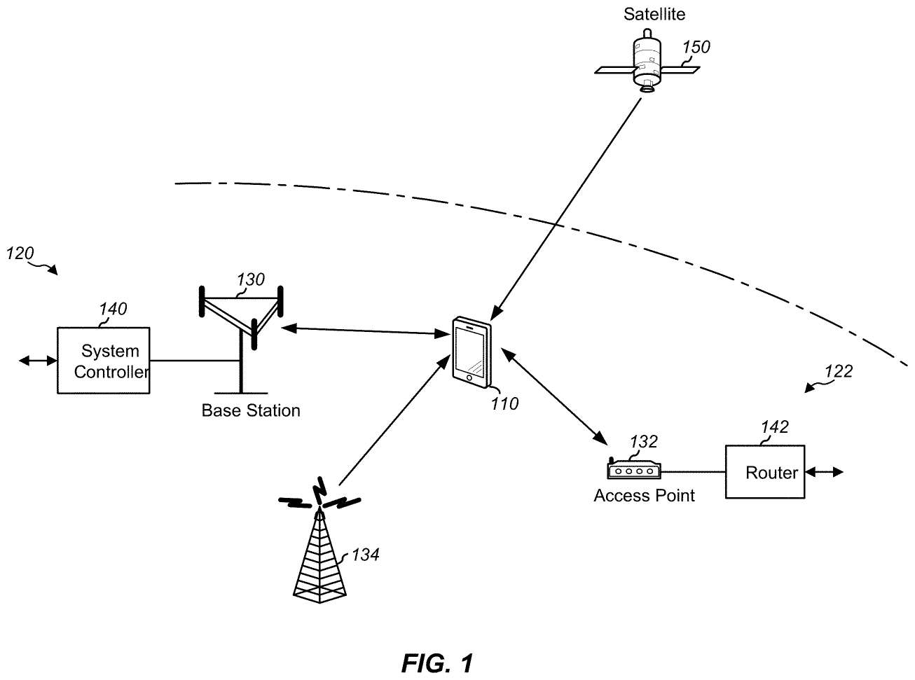

Referring to FIG. 1, a wireless device 110 capable of communicating with different wireless communication systems 120 and 122 is shown. The wireless system 120 may be a Code Division Multiple Access (CDMA) system (which may implement Wideband CDMA (WCDMA), cdma2000, or some other version of CDMA), a Global System for Mobile Communications (GSM) system, a Long Term Evolution (LTE) system, a 5G system, etc. The wireless system 122 may be a wireless local area network (WLAN) system, which may implement IEEE 802.11, etc. For simplicity, FIG. 1 shows the wireless system 120 including a base station 130 and a system controller 140, and the wireless system 122 including an access point 132 and a router 142. In general, each system may include any number of stations and any set of network entities.

The wireless device 110 may also be referred to as a user equipment (UE), a mobile device, a mobile station, a terminal, an access terminal, a subscriber unit, a station, etc. The wireless device 110 may be a cellular phone, a smart phone, a tablet, a wireless modem, a personal digital assistant (PDA), a handheld device, a laptop computer, a smart book, a netbook, a cordless phone, a wireless local loop (WLL) station, an internet of things (IoT) device, a medical device, a device in an automobile, a Bluetooth device, etc. The wireless device 110 may be equipped with any number of antennas. Multiple antennas may be used to provide better performance, to simultaneously support multiple services (e.g., voice and data), to provide diversity against deleterious path effects (e.g., fading, multipath, and interference), to support multiple-input multiple-output (MIMO) transmission to increase data rate, and/or to obtain other benefits. The wireless device 110 may be capable of communicating with one or more wireless systems 120 and/or 122. The wireless device 110 may also be capable of receiving signals from broadcast stations (e.g., a broadcast station 134). The wireless device 110 may also be capable of receiving signals from satellites (e.g., a satellite 150), for example in one or more global navigation satellite systems (GNSS). Further, the wireless device 110 may be configured to communicate directly with other wireless devices (not illustrated), e.g., without relaying communications through a base station or access point or other network device.

In general, the wireless device 110 may support communication with any number of wireless systems, which may employ any radio technologies such as WCDMA, cdma2000, LTE, 5G, GSM, 802.11, GPS, etc. The wireless device 110 may also support operation on any number of frequency bands.

The wireless device 110 may support operation at a very high frequency, e.g., within millimeter-wave (MMW) frequencies from 30 to 300 gigahertz (GHz) or higher. For example, the wireless device 110 may be cable to operate with dual bands. One such configuration includes the 28 GHz and 39 GHz bands. Other very high frequency (e.g., 5G) bands, such as 60 GHz or higher frequency bands, may also be realized with the wireless device 110 and implemented as one of the dual bands. The wireless device 110 may include an antenna system to support CA operations at MMW frequencies. The antenna system may include a number of antenna elements, with each antenna element being used to transmit and/or receive signals. The terms “antenna” and “antenna element” are synonymous and are used interchangeably herein. Generally, each set of antenna elements may be implemented with a patch antenna or a strip-shaped radiator. A suitable antenna type may be selected for use based on the operating frequency of the wireless device, the desired performance, etc. In an exemplary design, an antenna system may include a number of patch and/or strip-type antennas supporting operation at MMW frequencies.

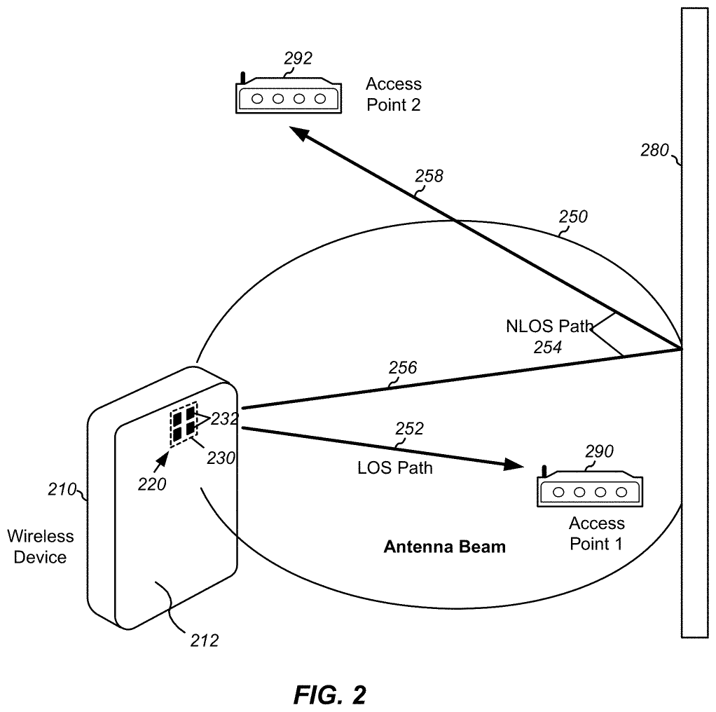

Referring to FIG. 2, an exemplary design of a wireless device 210 with a 2-D antenna system 220 is shown. In this exemplary design, antenna system 220 includes a 2×2 array 230 of four patch antennas 232 (i.e., radiators) formed on a single geometric plane corresponding to a back surface of wireless device 210 (e.g., a backside array). Those of skill in the art will understand that other array configurations may be utilized. For example, a 1×4 array may be used or an array with a greater number of columns and/or rows may be used.

While the antenna system 220 is visible in FIG. 2, in operation the patch array may be disposed on a PC board, antenna carrier, or other assembly located on an inside surface of a device or cover 212. The patch antenna array 230 has an antenna beam 250, which may be formed to point in a direction that is orthogonal to the plane on which patch antennas 232 are formed or in a direction that is within a certain angle of orthogonal, for example up to 60 degrees in any direction from orthogonal. Wireless device 210 can transmit signals directly to other devices (e.g., access points) located within antenna beam 250 and can also receive signals directly from other devices located within antenna beam 250. Antenna beam 250 thus represents a line-of-sight (LOS) coverage of wireless device 210.

An antenna element may be formed on a plane corresponding to a surface of a wireless device and may be used to transmit and/or receive signals. The antenna element may have a particular antenna beam pattern and a particular maximum antenna gain, which may be dependent on the design and implementation of the antenna element. Multiple antenna elements may be formed on the same plane and used to improve antenna gain. Higher antenna gain may be especially desirable at MMW frequency since (i) it is difficult to efficiently generate high power at MMW frequency and (ii) attenuation loss may be greater at MMW frequency.

For example, an access point 290 (i.e., another device) may be located inside the LOS coverage of wireless device 210. Wireless device 210 can transmit a signal to access point 290 via a line-of-sight (LOS) path 252. Another access point 292 may be located outside the LOS coverage of wireless device 210. Wireless device 210 can transmit a signal to access point 292 via a non-line-of-sight (NLOS) path 254, which includes a direct path 256 from wireless device 210 to a wall 280 and a reflected path 258 from wall 280 to access point 292.

In general, the wireless device 210 may transmit a signal via a LOS path directly to another device located within antenna beam 250, e.g., as shown in FIG. 2. Ideally, this signal may have a much lower power loss when received via the LOS path. The low power loss may allow wireless device 210 to transmit the signal at a lower power level, which may enable wireless device 210 to conserve battery power and extend battery life.

The wireless device 210 may transmit a signal via a NLOS path to another device located outside of antenna beam 250, e.g., as also shown in FIG. 2. This signal may have a much higher power loss when received via the NLOS path, since a large portion of the signal energy may be reflected, absorbed, and/or scattered by one or more objects in the NLOS path. Wireless device 210 may transmit the signal at a high power level in an effort to ensure that the signal can be reliably received via the NLOS path.

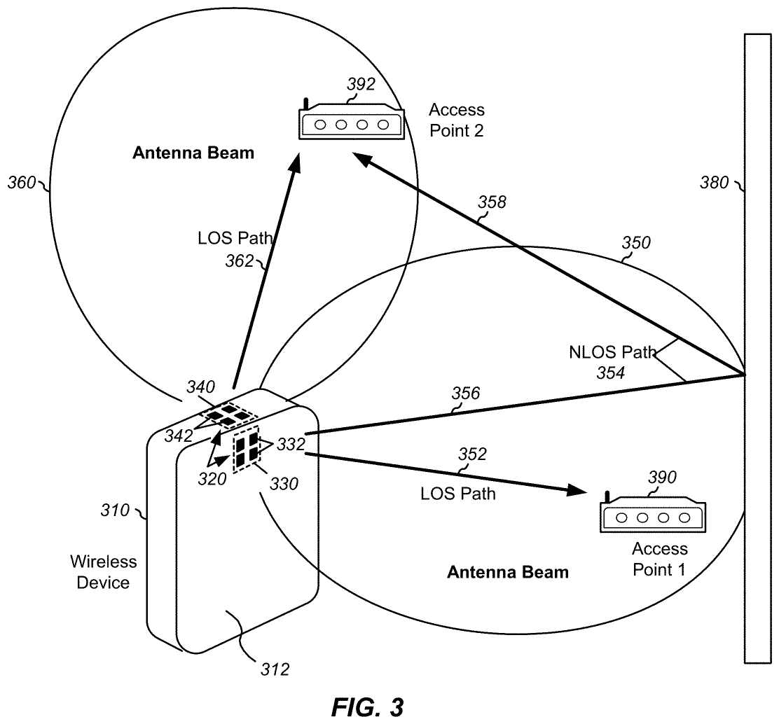

Referring to FIG. 3, an exemplary design of a wireless device 310 with a 3-D antenna system 320 is shown. In this exemplary design, antenna system 320 includes (i) a 2×2 array 330 of four patch antennas 332 formed on a first plane corresponding to the back surface of wireless device 310 and (ii) a 2×2 array 340 of four patch antennas 342 formed on a second plane corresponding to the top surface of wireless device 310 (e.g., an end-fire array). The patch antenna arrays 330, 340 are disposed on the inside of a device cover 312. The antenna array 330 has an antenna beam 350, which points in a direction that is orthogonal to the first plane on which patch antennas 332 are formed. Antenna array 340 has an antenna beam 360, which points in a direction that is orthogonal to the second plane on which patch antennas 342 are formed. In an example, the arrays 330 and 340 may point in a direction that is within a certain angle of orthogonal, for example up to 60 degrees in any direction from orthogonal. Antenna beams 350 and 360 thus represent the LOS coverage of wireless device 310. While the arrays 330 and 340 are each illustrated as a 2×2 array in FIG. 3, one or both may include a greater or fewer number of antennas, and/or the antennas may be disposed in a different configuration. For example, one or both of the arrays 330 and 340 may be configured as a 1×4, 1×8, 2×4 or other array dimensions.

An access point 390 (i.e., another device) may be located inside the LOS coverage of antenna beam 350 but outside the LOS coverage of antenna beam 360. Wireless device 310 can transmit a first signal to access point 390 via a LOS path 352 within antenna beam 350. Another access point 392 may be located inside the LOS coverage of antenna beam 360 but outside the LOS coverage of antenna beam 350. Wireless device 310 can transmit a second signal to access point 392 via a LOS path 362 within antenna beam 360. Wireless device 310 can transmit a signal to access point 392 via a NLOS path 354 composed of a direct path 356 and a reflected path 358 due to a wall 380. Access point 392 may receive the signal via LOS path 362 at a higher power level than the signal via NLOS path 354.

The wireless device 310 shows an exemplary design of a 3-D antenna system comprising two 2×2 antenna arrays 330 and 340 formed on two planes (e.g., backside and end-fire arrays). In general, a 3-D antenna system may include any number of antenna elements formed on any number of planes pointing in different spatial directions. The planes may or may not be orthogonal to one another. Any number of antennas may be formed on each plane and may be arranged in any formation. The antenna arrays 330, 340 may be formed in an antenna carrier substrate and/or within the device cover 312.

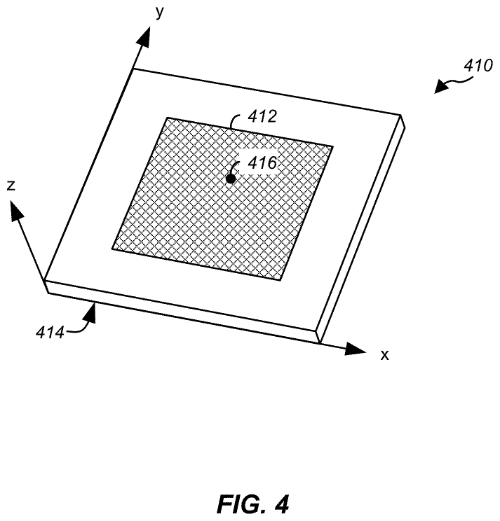

Referring to FIG. 4, an exemplary design of a patch antenna 410 suitable for MMW frequencies is shown. The patch antenna 410 includes a radiator such as a conductive patch 412 formed over a ground plane 414. In an example, the patch 412 has a dimension (e.g., 2.5×2.5 mm) selected based on the desired operating frequency. The ground plane 414 has a dimension (e.g., 4.0×4.0 mm) selected to provide the desired directivity of patch antenna 410. A larger ground plane may result in smaller back lobes. In an example, a feed point 416 is located near the center of patch 412 and is the point at which an output RF signal is applied to patch antenna 410 for transmission. Multiple feed points may also be used to vary the polarization of the patch antenna 410. For example, at least two conductors may be used for dual polarization (e.g., a first conductor and a second conductor may be used for a horizontal-pol feed line and a vertical-pol feed line). The locations and number of the feed points may be selected to provide the desired impedance match to a feedline. Additional patches may be assembled in an array (e.g., 1×2, 1×3, 1×4, 2×2, 2×3, 2×4, 3×3, 3×4, etc. . . . ) to further provide a desired directivity and sensitivity. The ground plane 414 may be disposed under all of the patches in the array.

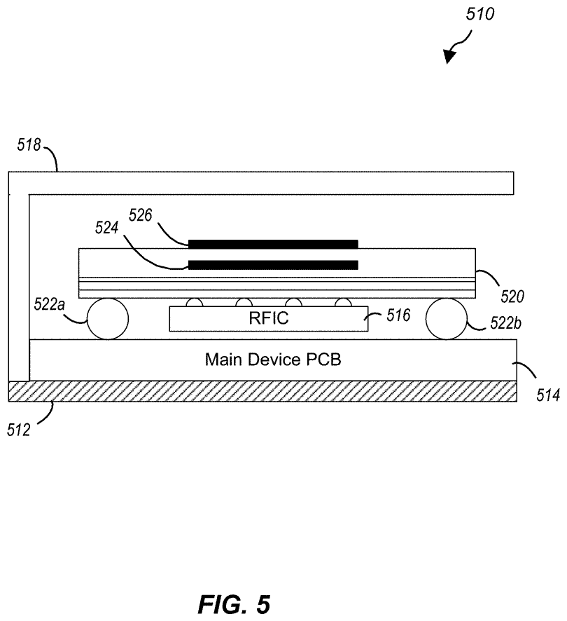

Referring to FIG. 5, a side view of an example patch antenna array in a wireless device 510 is shown. The wireless device 510 includes a display device 512, a device cover 518, and a main device printed circuit board (PCB) 514. The main device PCB 514 may be at least one printed circuit board or a plurality of printed circuit boards. In the embodiment illustrated in FIG. 5, a MMW module PCB 520 is operably coupled to the main device PCB 514 via at least one conductor 522a-b, which may be configured as one or more ball grid arrays (BGA). The BGA may be configured to enable one or more signals to flow between the MMW module PCB 520 and the main device PCB 514. The MMW module PCB 520 may include at least one patch antenna array 524 and corresponding passive patches 526 to form a wideband antenna. The MMW module PCB 520 also includes signal and ground layers in the illustrated embodiment. At least one radio frequency integrated circuit (RFIC) 516 may be mounted to the MMW module PCB 520 and operate to adjust the power and/or the radiation beam patterns associated with the patch antenna array 524. In some embodiments, the RFIC 516 is also configured to upconvert signals for transmission and/or downconvert received signals. The RFIC 516 may be an example of an antenna controller and may be configured to utilize phase shifters and hybrid antenna couplers to control the power directed to the antenna array and to control the resulting beam pattern. The MMW module PCB 520 is configured in a backside configuration in the embodiment illustrated in FIG. 5 to generate a beam on the back side (i.e., opposite the display 512) of the wireless device 510. In some embodiments, the MMW module PCB 520 is implemented as a substrate configured as a routing layer which is formed separate from one or more of the antennas 524, 526 and coupled to such antennas. For example, each antenna 524 (and optionally including 526) may be formed as a discrete component which is coupled to the routing layer, or several different antennas may be formed together in a common stackup that is coupled to the routing layer. The size, stackup, type of material, type of antenna (e.g., patch or dipole), etc. that forms an antenna portion separate from the PCB 520 may vary between antenna different antenna portions.

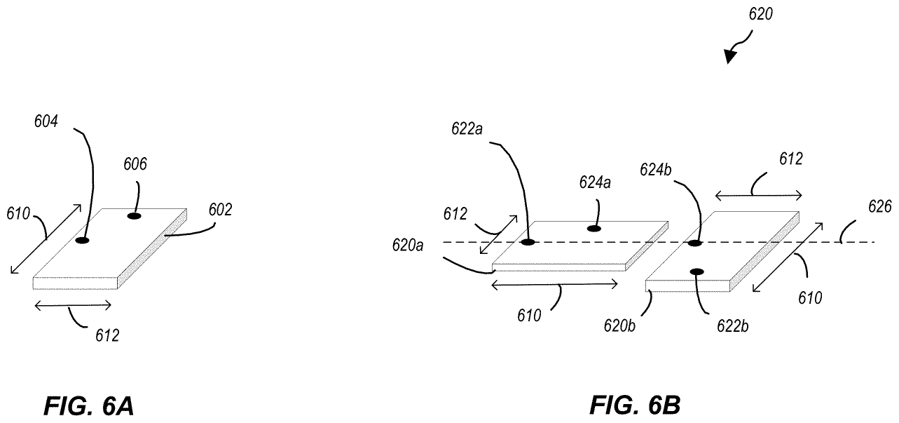

Referring to FIG. 6A, with further reference to FIG. 5, an example of a dual-band dual-feed patch antenna is shown. The antenna includes a metallic patch 602 in a rectangular shape with a first dimension 610 (e.g., length) and a second dimension 612 (e.g., width). The metallic patch 602 includes two parallel sides of the first dimension 610 and two parallel sides of the second dimension 612. The metallic patch 602 may be a microstrip patch such as in the patch antenna array 524, disposed on or coupled to a substrate such as the MMW module PCB 520. The thickness of the substrate may vary based on the dielectric constant of the substrate and other RF performance requirements such as gain, return loss, impedance and bandwidth. Antenna manufacturing techniques may also impact the thickness of the substrate or antenna portion coupled to the substrate. The first dimension 610 and second dimension 612 are based on the desired bands of operation in a dual-band system. That is, each of the bands in the dual-band system will be utilized with the metallic patch 602 and the first and second dimensions 610, 612 will be based at least in part on the wavelengths of the desired bands. For example, in a 28 GHz/39 GHz system the first dimension 610 is approximately 2.5 mm and the second dimension 612 is approximately 2.0 mm. In some embodiments, the dimension of each side is approximately one quarter of the wavelength of signals in the band being communicated with that side. The lengths of the dimension 610, 612 may vary based on the dielectric constant of the substrate of the module PCB 520 or of a substrate with which a separate antenna portion is formed. Other frequency bands may use other dimensions. In the embodiment illustrated in FIG. 6, a first feed point 604 is disposed along an edge approximately halfway along the first dimension 610, and a second feed point 606 is disposed approximately halfway along the edge corresponding to the second dimension 612. The distances of the feed points 604, 606 from their respective edges may vary based on impedance measurements (i.e., the locations of the feed points 604, 606 may be used for impedance matching). In an example, a 39 GHz signal may utilize the first feed point 604 and a 28 GHz signal may utilize the second feed point 606. In other embodiments one or both of the feed points 604, 606 are disposed at a location other than halfway along its respective edge.

Referring to FIG. 6B, with further reference to FIG. 6A, an example of a dual-band, dual-feed, dual-polarization patch antenna array 620 is shown. The antenna array 620 includes a first metallic patch 620a and a second metallic patch 620b. Each of the metallic patches 620a-b are the rectangular shape of the metallic patch 602 in FIG. 6A, including the first dimension 610 and the second dimension 612. The orientation of the second metallic patch 620b is rotated 90 degrees relative to the first metallic patch 620a, as depicted in FIG. 6B. A dimensional centerline 626 is illustrated to show the relative alignments between the center of the first metallic patch 620a along the second dimension 612 and the center of the second metallic patch 620b along the first dimension 610. The spacing between the respective inside edges of the first and second patches 620a-b may vary based on the operational frequencies. In the 28 GHz/39 GHz example, the spacing between the inside edges may be approximately 0.5 mm. The antenna array 620 includes four feed points for the respective horizontal and vertical polarization of each of the desired bands. The horizontal and vertical polarizations are examples of a first polarization and a second polarization. The feed points include a first band horizontal feed point 622a, a first band vertical feed point 622b, a second band vertical feed point 624a, and a second band horizontal feed point 624b. Thus, each metallic patch 620a-b receives a horizontally polarized signal from one band and a vertically polarized signal from the other band in a dual-band system. For example, in a 28 GHz/39 GHz system, the 28 GHz (H) feed point is the first band horizontal feed point 622a, and the 28 GHz (V) feed point is the first band vertical feed point 622b. The 39 GHz (V) feed point is the second band vertical feed point 624a, and the 39 GHz (H) feed point is the second band horizontal feed point 624b. The antenna array 620 may provide improved bandwidth in both bands with dual-polarization in both bands. Further, the antenna array feed points described herein may enable improved port-to-port isolation between horizontal and vertical polarization ports at the same frequency band, which may enhance polarization MIMO performance, and moreover the separated 28 GHz and 39 GHz feeds enable inter-CA operation and may result in improved PA/LNA performance with both bands. For example, antenna array 620 may simultaneously receive or transmit on one or multiple component carriers such as the 28 GHz and 39 GHz bands.

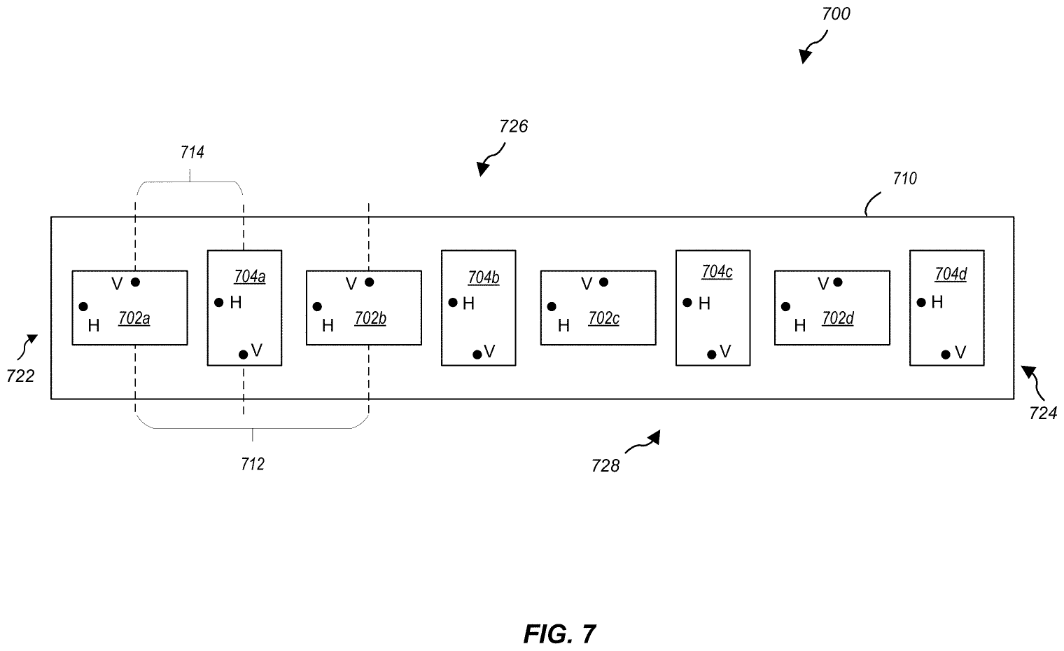

Referring to FIG. 7, with further reference to FIGS. 5, 6A and 6B, a top view of an example dual-feed dual-band interleaved antenna array 700 is shown. The antenna array 700 includes a plurality of patch antennas disposed on or within a dielectric substrate 710 in the illustrated embodiment. In an example, the dielectric substrate may be a prepreg material with a dielectric constant of approximately 3.3-4.0. As discussed above, however, one or more antennas in the antenna array 700 may be disposed on or within a substrate separate from the substrate on or in which one or more other antennas of the array 700 are formed. The antenna array 700 may be operably coupled to, or integrated with, a MMW module PCB 520 (e.g., the antenna array 700 is an example of the patch array 524 in FIG. 5). The plurality of patch antennas in the antenna array 700 include a first set of rectangular patches 702a-d in a landscape orientation and a second set of rectangular patches 704a-d in a portrait orientation. Each of the rectangular patches 702a-d, 704a-d is approximately rectilinear with a length dimension that is longer than a width dimension. The length of the rectangle is measured along the major axis of the rectangle, and the shorter width is measured along the minor axis of the rectangle. As used herein, a landscape orientation means that the major axis of a rectangle is approximately parallel to a major axis of the antenna array 700, and a portrait orientation means that the minor axis of a rectangle is approximately parallel to the major axis of the antenna array 700. As depicted in FIG. 7, a centerline of each of the patches in the first set of rectangular patches 702a-d is approximately aligned with a centerline of each of the patches in the second set of rectangular patches 704a-d. Each of the patches in the first set of rectangular patches 702a-d are approximately a half-wavelength of an operational frequency (e.g., 28 GHz) distance 712 from one another (e.g., measured from a center of one of the patches 702 to a center of an adjacent patch 702). The patches in the second set of rectangular patches 704a-d are interleaved between the patches in the first set of rectangular patches 702a-d such that there is approximately a quarter wavelength distance 714 of the operational frequency between a centerline of the landscape oriented patches and a centerline of the portrait oriented patches. In a 5G system utilizing the 28 GHz and 39 GHz bands, the half-wavelength distance 712 may be approximately 5.7-6.0 mm and the quarter-wave distance 714 may be approximately 2.7-3.0 mm. The distances may vary based on the dielectric constant of the substrate(s) 710.

The antenna array 700 includes four dual-band, dual-feed, dual-polarization patch antenna array 620 depicted in FIG. 6B. The array 700 is eight rectangular patches (i.e., four sets of two rectangular patches), such that a first subarray includes a first patch 702a and a second patch 704a, a second subarray includes a third patch 702b and fourth patch 704b, a third subarray includes a fifth patch 702c and a sixth patch 704c, and a fourth subarray includes a seventh patch 702d and an eighth patch 704d. The four subarrays in the antenna 700 are an example and not a limitation as an antenna 700 may have fewer or more pairs of patches. Further, the number of patches 702 may be unequal to the number of patches 704. Each of the patches 702a-d, 704a-d includes a vertically polarized feed point (V) and a horizontally polarized feed point (H) such that each patch includes one feed point for each of the two bands in a dual-band system. For example, each of the patches in the first set of rectangular patches 702a-d includes a feed point (H) for a horizontally polarized signal in a first band and a feed point (V) for a vertically polarized signal in a second band, and each of the patches in the second set of rectangular patches 704a-d includes a feed point (H) for a horizontally polarized signal in the second band and a feed point (V) for a vertically polarized signal in the first band. In a 5G network, for example, the first band may be 28 GHz and the second band may be 39 GHz. Specifically, the first set of rectangular patches 702a-d may be configured with a 28 GHz horizontally polarized feed point (H) and a 39 GHz vertically polarized feed point (V), and the second set of rectangular patches 704a-d may be configured with a 28 GHz vertically polarized feed point (V) and a 39 GHz horizontally polarized feed point (H). The four sets of patch pairs (e.g., 702a, 704a; 702b, 704b; 702c, 704c; 702d, 704d) are an example and not a limitation as fewer or additional patch pairs may be used in the array 700. In general, the array 700 includes a first plurality of rectangular patches 702 in a first orientation, and a second plurality of rectangular patches 704 in a second orientation, such that the first plurality of rectangular patches 702 and the second plurality of rectangular patches 704 are disposed in an interleaved order in a row where each rectangular patch in the first plurality of rectangular patches is adjacent to at least one rectangular patch in the second plurality of rectangular patches.

In the embodiment illustrated in FIG. 7, the feed points H for all of the patches 702 and 704 are disposed on a first side 722 of each of those patches (e.g., to the left of a center point of each of the patches in the illustration). Disposing the feed points H in this way ensures that they are adequately spaced from each other and that isolation between these feed points is increased. In contrast, if any of the feed points H were disposed on a second side 724 (e.g., to the right of a center point of each of the patches in the illustration) of the patches (other than on the patch 704d), the feed point disposed on the second side 624 would be nearer to a feed point of an adjacent patch disposed on the first side 622 than in the illustrated embodiments and may reduce isolation. In this description, because the first side 722 of all of the patches 702, 704 is on the left in the illustration, the sides 722 of all of the patches 702, 704 are considered to be “similarly disposed;” further, because the second side 724 of all of the patches 702, 704 is on the right in the illustration, the sides 724 of all of the patches 702, 704 are considered to be “similarly disposed.”

Further, in the embodiment illustrated in FIG. 7, the feed points V for the patches 702 are disposed on a third side 726 of the patches 702 (e.g., above a center point of each of the patches 702 in the illustration), and the feed points V for the patches 704 are disposed on a fourth side 728 of the patches 704 (e.g., below a center point of each of the patches 704 in the illustration). When the patches 702, 704 are shaped to have two sets of two parallel sides, as described above, the fourth side 728 may be substantially (parallel to and) opposite the third side 726. Similar to the placement of the feed points H, disposing the feed points V in the configuration illustrated in FIG. 7 may increase isolation. In this description, because the third side 726 of all of the patches 702, 704 is on the top in the illustration, the sides 726 of all of the patches 702, 704 are considered to be “similarly disposed;” further, because the fourth side 728 of all of the patches 702, 704 is on the bottom in the illustration, the sides 728 of all of the patches 702, 704 are considered to be “similarly disposed.”

While the patches 602, 702, and 704 are described above as being rectangular in shape, the patches 602, 702, and 704 may be configured in any other shape that can be coupled to two feeds for respective frequency bands with respective polarizations. For example, the patches in the embodiments described herein may be configured in an elliptical shape, with the major axis corresponding to a first frequency and the minor axis corresponding to a second frequency. A first feed for the first frequency and for a first polarization may be disposed along the major axis (away from a point where the major and minor axes intersect), and a second feed for the second frequency and for a second polarization may be disposed along the minor axis (away from a point where the major and minor axes intersect) in a first set of the patches in some embodiments. A second set of the patches in such embodiments may be (interleaved with and) rotated with respect to the first set of patches, and may have a third feed for the first frequency and for the second polarization disposed along the major axis (away from a point where the major and minor axes intersect), and a fourth feed for the second frequency and for the first polarization disposed along the minor axis (away from a point where the major and minor axes intersect). Other configurations may be implemented as well.

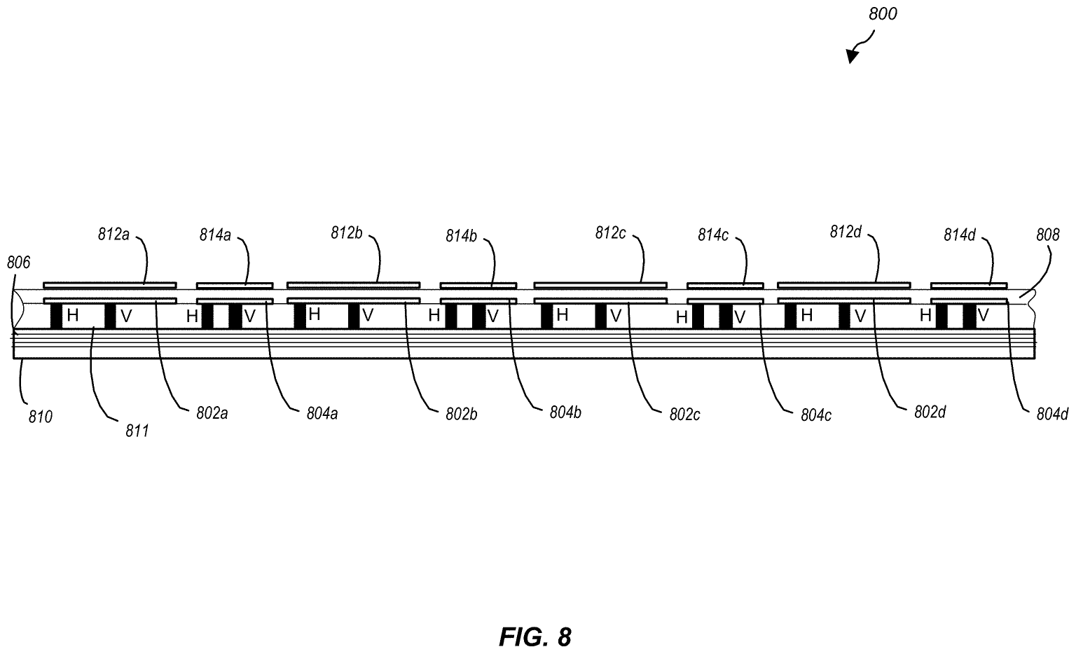

Referring to FIG. 8, with further reference to FIG. 7, a side view of an example dual-feed dual-band interleaved antenna array 800 is shown. The antenna array 800 includes a substate 810 and plurality of interleaved landscape oriented patches 802a-d and portrait oriented patches 804a-d, with each patch 802a-d, 804a-d operably coupled to a respective signal line 806 with a via in the substrate 810. The landscape oriented patches 802a-d are examples of the first set of rectangular patches 702a-d, and the portrait oriented patches 804a-d are examples of the second set of rectangular patches 704a-d. The substrate 810 may be operably coupled to, or integrated with, the MMW module PCB 520. The vias are labeled ‘H’ and ‘V’ for the respective horizontally and vertically polarized signals. In an example, the substrate 810 is a planar substrate with a top surface and a bottom surface, and one or more signal lines 806 are disposed between the top surface and the bottom surface of the substrate 220. The substrate 810 may include a conductive cladding 811 (e.g., Cu, Ag) configured as a ground plane. The substrate may comprise a printed circuit board and the signal lines 806 may be microstrip lines configured to transfer electrical signals to and from a patch 802a-d, 804a-d. For example, the signal lines 806 may be configured to operably couple the patch vias with the RFIC 516. In an example manufacturing process, the dual-feed dual-band interleaved antenna array 800 may be constructed by forming successive layers 808 on the substrate 810. In an example, the layers 808 may be a printed circuit board material (e.g., prepreg) with a dielectric constant in the range of 3.3-4.0. In other examples, one or more of the patches 802, 804 are manufactured separate from the substrate 810 (e.g., the layers 808 may be separate from the portion of the substrate in which the signal lines 806 are implemented and/or unique to each patch 802a-d, 804a-d).

In an example, the dual-feed dual-band interleaved antenna array 800 may include a plurality of passive patch elements including a first set of passive patch elements 812a-d, and a second set of passive patch elements 814a-d. The passive patch elements 812a-d, 814a-d are examples of the passive patches 526 in FIG. 5. The first set of passive patch elements 812a-d is an example of a first plurality of passive patch elements, and the second set of patch elements is an example of a second plurality of passive patch elements. In some embodiments, the dimensions and orientations of the patches in the first set of passive patches 812a-d are approximately the same as the landscape oriented patches 802a-d, and the dimensions and orientations of the patches in the second set of passive patch elements 814a-d are approximately the same as the portrait oriented patches 804a-d. The dimensions and orientations of the passive patch elements 812a-d, 814a-d, however, may vary based on desired beaming and gain performance. In some embodiments, the passive patch elements 812a-d, 814a-d are larger in one or more dimensions than the patches 802a-d, 804a-d. In an example, the expected operational bands of the array 800 include 28 GHz and 39 GHz, the distance between the active patch elements 802a-d, 804a-d and the respective passive patch elements 812a-d, 814a-d is approximately 0.3 millimeters. While the array 800 depicts an 1×8 array of interleaved patches, other array dimensions such as 1×2, 1×4, 1×4, 1×10, etc. may be used. In an example, wider arrays of interleaved patches such as 2×2, 2×4, 2×6, 2×8, 4×4, 4×6, 4×8, 6×6, 6×8, 8×8, etc. may be used. In such embodiments, each row may be comprised of patches having interleaved portrait and landscape configurations, and each column may also be comprised of patches having interleaved portrait and landscape configurations. The antenna array 800 may be integrated in the MMW module PCB 520, or disposed on one or more antenna carriers and operably coupled to the RFIC 516 via one or more connector cables or coupling mechanisms. 3-D solutions may also be realized such that multiple antenna arrays 800 may be disposed on two or more sides of a mobile device which may correspond with the patch antenna arrays 330, 340 in FIG. 3. More than one antenna carrier assembly (i.e., multiple parts) may be used to support the antenna array 800. In an example, a device cover may be used as the antenna carrier. Other structures may also be used to secure radiator arrays on one or more geometric planes.

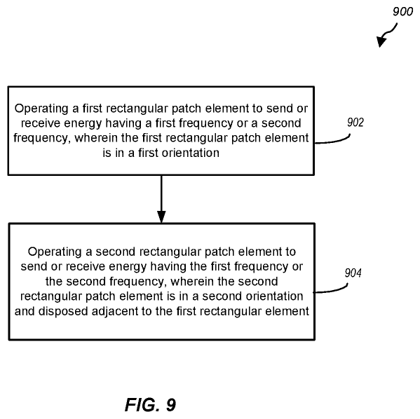

Referring to FIG. 9, with further reference to FIGS. 1-9, a method 900 for sending or receiving a signal with a dual-feed dual-band interleaved antenna array includes the stages shown. The method 900 is, however, an example only and not limiting. The method 900 may be altered, e.g., by having stages added, removed, rearranged, combined, performed concurrently, and/or having single stages split into multiple stages.

At stage 902, the method 900 includes operating a first rectangular patch element to send or receive energy having a first frequency or a second frequency, wherein the first rectangular patch element is in a first orientation. The radio frequency integrated circuit 516 is a means for operating the first rectangular patch element. Referring to FIG. 6B, a first rectangular patch 620 includes a side of first dimension 610 and a side of second dimension 612, such that the length of the first dimension 610 is greater than the length of the second dimension 612. The first rectangular patch 620 is in a first orientation, such as a landscape orientation as compared to the second rectangular patch 620b. The first rectangular patch may have one or more feed points such as the first band horizontal feed point 622a and the second band vertical feed point 624a. The first band corresponds to energy at a first frequency and the second band corresponds to energy at a second frequency. In an example, the first frequency is 28 GHz and the second frequency is 39 GHz. Other frequencies may be used.

At stage 904, the method 900 includes operating a second rectangular patch element to send or receive energy having the first frequency or the second frequency, wherein the second rectangular patch element is in a second orientation and disposed adjacent to the first rectangular element. The radio frequency integrated circuit 516 is a means for operating the second rectangular patch element. Referring to FIG. 6B, a second rectangular patch 620b including sides having the same dimensions 610,612 as the first rectangular patch, such that the side of the second rectangle patch having the first dimension 610 is disposed adjacent and parallel to the side of the first rectangular patch having the second dimension 612. The second rectangular patch 620b may include a first band vertical feed point 622b and a second band horizontal feed point 624b. The dimensional centerline 626 is illustrated to show the relative orientations between the center of the first metallic patch 620a along the second dimension 612 and the center of the second metallic patch 620b along the first dimension 610. The first rectangular patch element 620a is in a landscape orientation as compared to a portrait orientation of the second rectangular patch element 620b. The spacing between the respective adjacent edges of the first and second patches 620a-b may vary based on the operational frequencies. In the 28 GHz/39 GHz example, the spacing between the inside edges may be approximately 0.5 mm.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Components, functional or otherwise, shown in the figures and/or discussed herein as being connected, coupled (e.g., communicatively coupled), or communicating with each other are operably coupled. That is, they may be directly or indirectly, wired and/or wirelessly, connected to enable signal transmission between them.

“About” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

What is claimed is:

1. A wireless device, comprising:
at least one radio frequency integrated circuit; and
at least one patch antenna array operably coupled to the least one radio frequency integrated circuit, comprising:
a first rectangular patch including a first side and a second side, wherein a length of the first side is greater than a length of the second side; and
a second rectangular patch including a first side and a second side of the same dimensions as the respective first side and the second side of the first rectangular patch, wherein the first side of the second rectangular patch is disposed adjacent and parallel to the second side of the first rectangular patch.

2. The wireless device of claim 1 wherein the first rectangular patch includes a first feed point disposed proximate to an edge of a third side that is opposite and parallel to the second side of the first rectangular patch, and a second feed point disposed proximate to an edge of the first side of the first rectangular patch.

3. The wireless device of claim 2 wherein the first feed point is configured to send or receive energy having a first frequency, and the second feed point is configured to send or receive energy having a second frequency.

4. The wireless device of claim 3 wherein the first frequency is approximately 28 GHz and the second frequency is approximately 39 GHz.

5. The wireless device of claim 3 wherein the second rectangular patch includes a first feed point disposed proximate to an edge of a third side that is opposite and parallel to the second side of the second rectangular patch, and a second feed point disposed proximate to an edge of the first side of the second rectangular patch.

6. The wireless device of claim 5 wherein the first feed point is configured to send or receive energy having the first frequency, and the second feed point is configured to send or receive energy having the second frequency.

7. The wireless device of claim 1 wherein a distance between a center of the first rectangular patch and a center of the second rectangular patch is approximately a quarter of a wavelength of an operational frequency.

8. The wireless device of claim 1 wherein the at least one patch antenna array further comprises:
a third rectangular patch of the same dimensions and orientation as the first rectangular patch and disposed adjacent to the second rectangular patch; and
a fourth rectangular patch of the same dimensions and orientation as the second rectangular patch and disposed adjacent to the third rectangular patch,
wherein the second rectangular patch is disposed between the first rectangular patch and the third rectangular patch, and
wherein the third rectangular patch is disposed between the second rectangular patch and the fourth rectangular patch.

9. A patch antenna array, comprising:
a first plurality of rectangular patches in a first orientation; and
a second plurality of rectangular patches in a second orientation, wherein the first plurality of rectangular patches and the second plurality of rectangular patches are disposed in an interleaved order in a row such that each rectangular patch in the first plurality of rectangular patches is adjacent to at least one rectangular patch in the second plurality of rectangular patches.

10. The patch antenna array of claim 9 wherein each of the rectangular patches in the first plurality of rectangular patches and the second plurality of rectangular patches includes a first feed point and a second feed point.

11. The patch antenna array of claim 10 wherein the first feed point is configured to send or receive energy having a first frequency and the second feed point is configured to send or receive energy having a second frequency.

12. The patch antenna array of claim 11 wherein the first feed point is configured to send or receive energy having the first frequency at a first polarization and the second feed point is configured to send or receive energy having the second frequency at a second polarization.

13. The patch antenna array of claim 10 wherein each rectangular patch of the first plurality of rectangular patches and the second plurality of rectangular patches has a first side, a second side, a third side, and a fourth side, wherein the four sides are similarly disposed in all of the rectangular patches in the first plurality of rectangular patches and the second plurality of rectangular patches, wherein the first feed point of all of the rectangular patches in the first plurality of rectangular patches and the second plurality of rectangular patches is disposed adjacent the first side, wherein the second feed point of all of the rectangular patches in the first plurality of rectangular patches is disposed adjacent the third side, and wherein the second feed point of all of the rectangular patches in the second plurality of rectangular patches is disposed adjacent the fourth side.

14. The patch antenna array of claim 13 wherein the first side is parallel the second side, wherein the third side is parallel to the fourth side, wherein the first plurality of rectangular patches comprises at least two rectangular patches, and wherein the second plurality of rectangular patches comprises at least two other rectangular patches.

15. The patch antenna array of claim 9 wherein the first plurality of rectangular patches includes four rectangular patches and the second plurality of rectangular patches includes four rectangular patches.

16. The patch antenna array of claim 9 wherein each of the rectangular patches in the first plurality of rectangular patches and the second plurality of rectangular patches includes two parallel sides that are approximately 2.5 millimeters in length and two parallel sides that are approximately 2.0 millimeters in length.

17. The patch antenna array of claim 9 further comprising:
a first plurality of passive patch elements in the first orientation; and
a second plurality of passive patch elements in the second orientation, wherein each of the passive patch elements in the first plurality of passive patch elements is disposed above a respective rectangular patch in the first plurality of rectangular patches, and each of the passive patch elements in the second plurality of passive patch elements is disposed above a respective rectangular patch in the second plurality of rectangular patches.

18. A method for operating an antenna system, comprising:
operating a first rectangular patch element to send or receive energy having a first frequency or a second frequency, wherein the first rectangular patch element is in a first orientation; and
operating a second rectangular patch element to send or receive energy having the first frequency or the second frequency, wherein the second rectangular patch element is in a second orientation and disposed adjacent to the first rectangular patch element.

19. The method of claim 18 further comprising:
operating the first rectangular patch element to send or receive energy having the first frequency at a first polarization and the second frequency at a second polarization; and
operating the second rectangular patch element to send or receive energy having the first frequency at the second polarization and the second frequency at the first polarization.

20. The method of claim 19 further comprising operating the antenna system in a carrier aggregation operation.
